(19) United States
(12) Patent Application Publication
(10) Pub. No.: US 2007/0216648 A1
(43) Pub. Date: Sep. 20, 2007

(54) Mouse

(75) Inventors: Chih-Kang Lo, Keelung City (TW); Ying-Hung Lin, Jhonghe City (TW); Hua-Chung Tseng, Bade City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/724,325

(22) Filed: Mar. 15, 2007

(30) Foreign Application Priority Data
Mar. 16, 2006 (TW) 95109052

(51) Int. Cl. G09G 5/08

(52) U.S. Cl. 345/163

(57) ABSTRACT

A mouse including a first microphone, a first speaker, an altitude sensor and a controller is provided. The altitude sensor is for outputting a first sensing signal and a second sensing signal when the mouse is horizontally and laterally orientated, respectively. The controller is electrically connected to the altitude sensor, the first microphone and the first speaker, respectively. The controller receives the first sensing signal and the second sensing signal, respectively, and switches the mouse among a mouse status and a speakerphone communication status. The controller controls the first microphone and the first speaker to respectively receive and output the voice when the mouse is at the speakerphone communication status.

This application claims the benefit of Taiwan application Serial No. 095109052, filed Mar. 16, 2006, the subject matter of which is incorporated herein by reference.

### BACKGROUND OF THE INVENTION

1. Field of the Invention

The invention relates in general to a mouse, and more particularly to a mouse selectively switched between a mouse status and a communication status according to the attitude of the mouse in the space.

2. Description of the Related Art

With the advance in science and technology, computer has become an indispensable device to modern people. Conventional computer includes a host, a screen, a keyboard and a mouse. The host is electrically connected to the screen, the keyboard and the mouse, respectively. The user can input an instruction to the computer via the keyboard and the mouse.

As cabled mouse is inconvenient in terms of use, wireless mouse is presented.

However, as Internet voice function is getting more and more popular, the wireless mouse only having the functions of enabling the user to shift screen index, click selection menu and roll screen reel is no more sufficient. Thus, the practicality of the mouse will be largely deteriorated.

### SUMMARY OF THE INVENTION

The invention is directed to a mouse selectively switched between a mouse status and a communication status according to the attitude of the mouse in the space sensed by an altitude sensor, largely increasing the practicality of the mouse.

According to a first aspect of the present invention, a mouse including a first microphone, a first speaker, an altitude sensor and a controller is provided. The altitude sensor is used for outputting a first sensing signal and a second sensing signal when the mouse is horizontally and laterally orientated, respectively. The controller is electrically connected to the altitude sensor, the first microphone and the first speaker, respectively. The controller receives the first sensing signal and the second sensing signal, respectively, and accordingly switches the mouse among a mouse status and a speakerphone communication status. The controller controls the first microphone and the first speaker to respectively receive and output the voice when the mouse is at the speakerphone communication status.

According to a second aspect of the present invention, a mouse including a first microphone, a first speaker, a second microphone, a second speaker, an altitude sensor and a controller is provided. The altitude sensor is used for outputting a first sensing signal and a third sensing signal when the mouse is horizontally and vertically orientated, respectively. The controller is electrically connected to the altitude sensor, the first microphone, the first speaker, the second mocrophone and the second speaker. The controller receives the first sensing signal and the third sensing signal, respectively, and accordingly switches the mouse among a mouse status and a handset communication status. The controller receives the third sensing signal and accordingly switches the mouse to a handset communication status.

According to a third aspect of the present invention, a mouse including an altitude sensor and a controller is provided. The altitude sensor is used for detecting the orientation of the mouse. When the first surface of the mouse faces downwards, the altitude sensor outputs a first sensing signal. When the second surface of the mouse faces downwards, the altitude sensor outputs a second sensing signal. When the third surface of the mouse faces downwards, the altitude sensor outputs a third sensing signal. The controller is electrically connected to the altitude sensor. When the controller receives the first sensing signal, the mouse is set at a first status. In the present embodiment of the invention, the first status is exemplified a mouse status. When the controller receives the second sensing signal, the mouse is set at a second status. In the present embodiment of the invention, the first status is exemplified a mouse status. When the controller receives the third sensing signal, the mouse is set at a third status. In the present embodiment of the invention, the first status is exemplified a mouse status.

According to a fourth aspect of the present invention, a mouse including a mouse shift sensing element, a speaker, a microphone, an altitude sensor and a controller is provided. The altitude sensor is used for detecting the orientation of the mouse. When the first surface of the mouse faces downwards, the altitude sensor outputs a first sensing signal. When the second surface of the mouse faces downwards, the altitude sensor outputs a second sensing signal. The controller is electrically connected to the altitude sensor, the mouse shift sensing element, speaker and microphone, respectively. When the controller receives the first sensing signal, the mouse shift sensing element is activated. When the controller receives the second sensing signal, the microphone is activated at a reception sensitivity level, and the speaker is activated at a volume magnification rate.

The invention will become apparent from the following detailed description of the preferred but non-limiting embodiments. The following description is made with reference to the accompanying drawings.

### BRIEF DESCRIPTION OF THE DRAWINGS

FIG. 1 is a circuit block diagram of a mouse and a computer according to a first embodiment;

FIG. 2 is a 3-D perspective of a mouse according to a first embodiment when the mouse is horizontally oriented;

FIG. 3 is a 3-D perspective when the mouse of FIG. 2 is laterally oriented;

FIG. 4 is a 3-D perspective when the mouse of FIG. 2 is vertically oriented;

FIG. 5 is a 3-D perspective when the lifting cover of the mouse of FIG. 4 is flipped open;

FIG. 6 is a circuit block diagram of a mouse and a computer according to a second embodiment;

FIG. 7 is a 3-D perspective of a mouse according to a second embodiment when the mouse is horizontally oriented;

FIG. 8 is a 3-D perspective when the mouse of FIG. 7 is laterally oriented;

FIG. 9 is a 3-D perspective when the mouse of FIG. 7 is vertically is oriented;

FIG. 10 is a 3-D perspective when the lifting cover of the mouse of FIG. 9 is flipped open;

FIG. 11 is a circuit block diagram of a mouse and a computer according to a third embodiment.

### DETAILED DESCRIPTION OF THE INVENTION

### First Embodiment

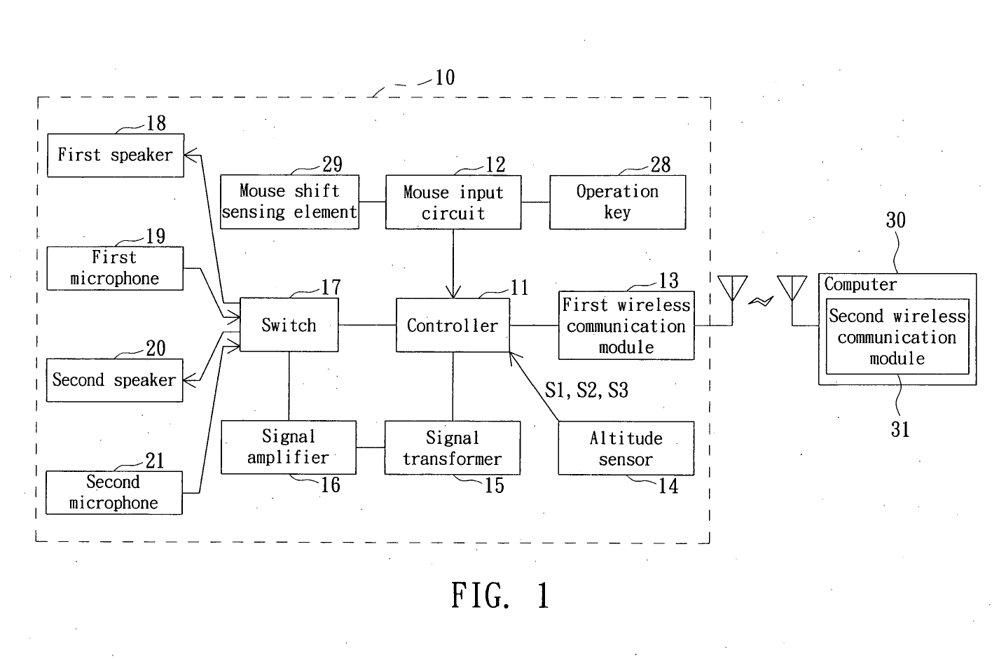

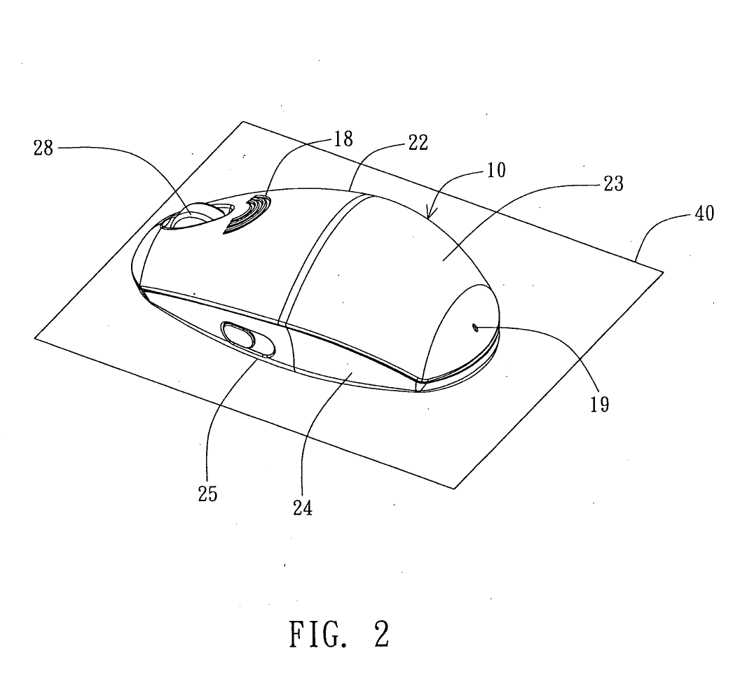

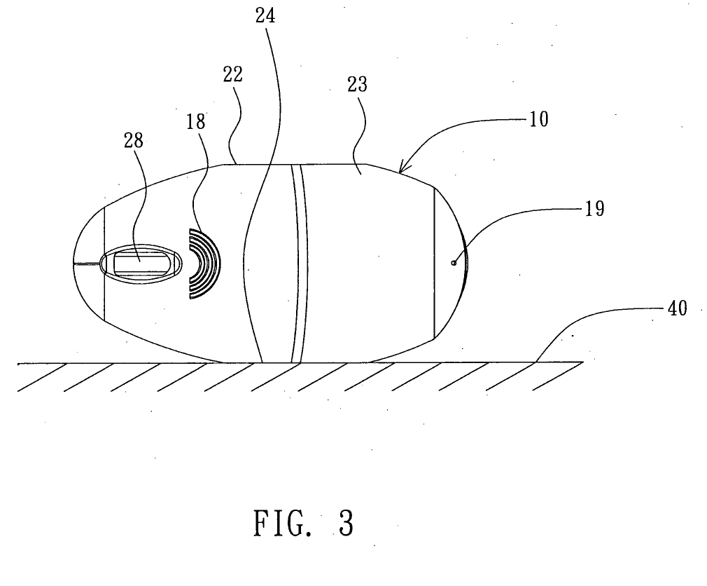

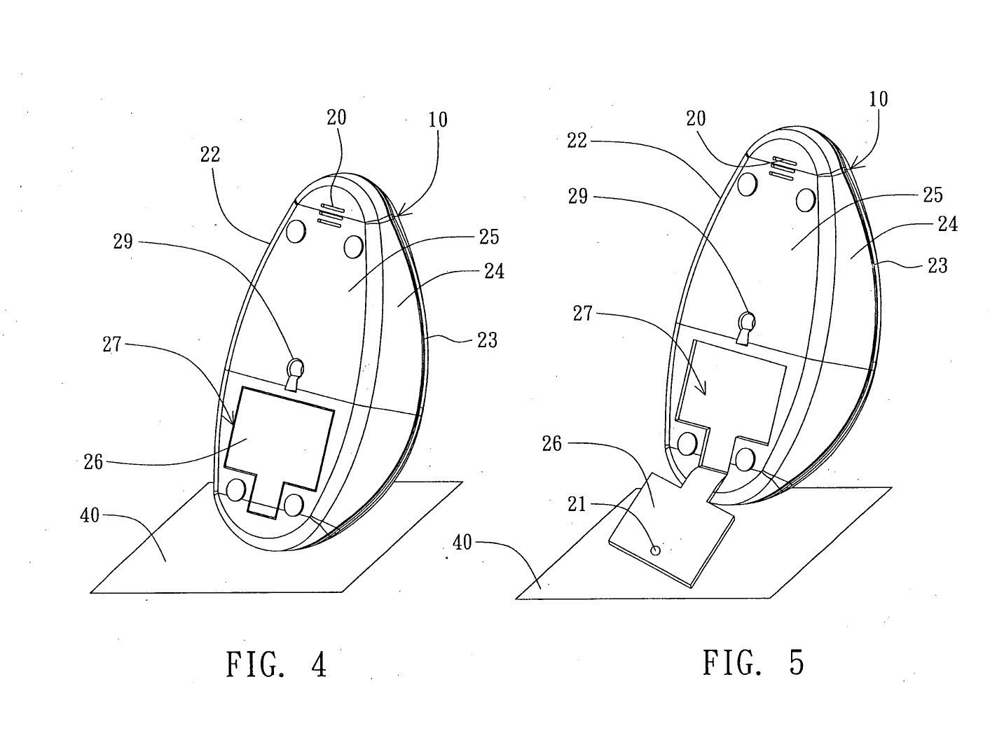

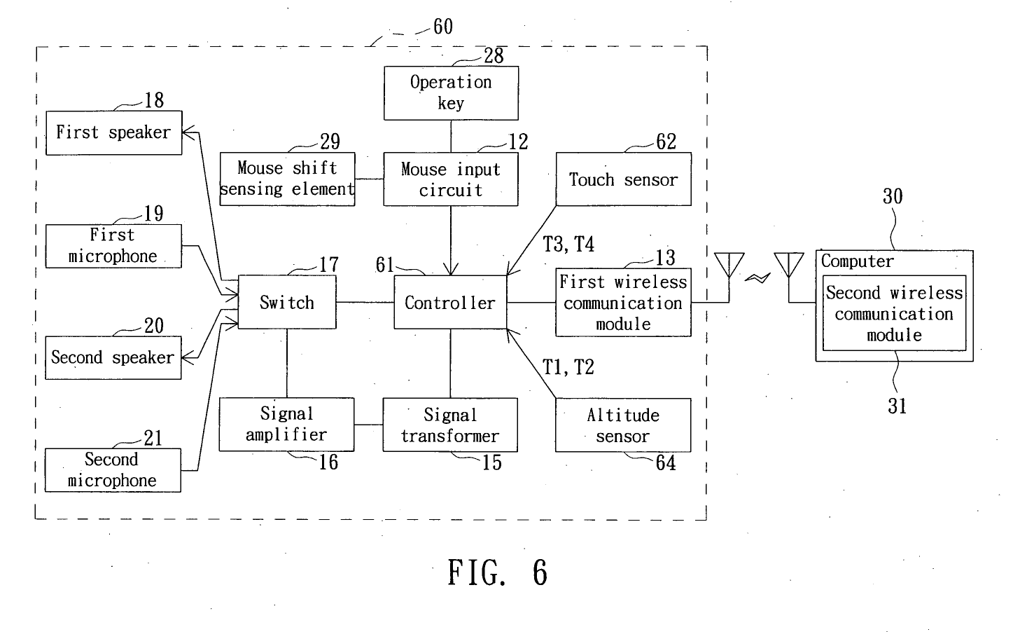

Referring to FIGS. 1˜5. FIG. 1 is a circuit block diagram of a mouse and a computer according to a first embodiment. FIG. 2 is a 3-D perspective of a mouse according to a first embodiment when the mouse is horizontally oriented. FIG. 3 is a 3-D perspective when the mouse of FIG. 2 is laterally oriented. FIG. 4 is a 3-D perspective when the mouse of FIG. 2 is vertically oriented. FIG. 5 is a 3-D perspective when the lifting cover of the mouse of FIG. 4 is flipped open.

As indicated in FIGS. 1˜5, the mouse 10 capable of performing wireless signal transmission with a computer 30 includes a first microphone 19, a first speaker 18, a second microphone 21, a second speaker 20, an altitude sensor 14 and a controller 11. The altitude sensor 14 is used for detecting the orientation of the mouse 10, and outputting a first sensing signal S1, a second sensing signal S2 and a third sensing signal S3 when the mouse 10 is horizontally, laterally and vertically orientated, respectively. That is, when the first surface of the mouse 10 faces downwards, the altitude sensor 14 outputs the first sensing signal S1; when the second surface of the mouse 10 faces downwards, the altitude sensor 14 outputs the second sensing signal S2; and when the third surface of the mouse 10 faces downwards, the altitude sensor 14 outputs the third sensing signal S3. The controller 11 is electrically connected to the altitude sensor 14, the first microphone 19, the first speaker 18, the second microphone 21 and the second speaker 20, respectively. The controller 14 receives the first sensing signal S1, the second sensing signal S2 and the third sensing signal S3, respectively, and accordingly switches the mouse 10 among a mouse status, a speakerphone communication status and a handset communication status. The controller 11 controls the first microphone 19 and the first speaker 18 to respectively receive and output the voice when the mouse is at the speakerphone communication status. The controller 11 controls the second microphone 21 and the second speaker 20 to respectively receive and output the voice when the mouse is at the handset communication status. That is, when the controller 11 receives the second sensing signal S2, the first microphone 19 and the first speaker 18 are activated to respectively receive and output the voice; and when the controller 11 receives the third sensing signal S3, the second microphone 21 and the second speaker 20 are activated to respectively receive and output the voice.

When the mouse 10 is at the mouse status, the user may use the mouse 10 to shift a screen index of the computer 30, click a screen selection menu of the computer 30, or roll a screen reel of the computer 30.

When the mouse 10 is at the speakerphone communication status, the user may use the mouse 10 to listen to music from the computer 30. Besides, the user can use the first microphone 19 and the first speaker 18 to talk with friends via the real-time communication platform of the computer 30. Examples of the real-time communication platform include MSN Message, Yahoo Message, Skype, Yahoo BB or Internet telephone.

When the mouse 10 is at the handset communication status, the user may use the mouse 10 as a handset telephone to talk with friends, which is indeed very convenient.

Therefore, the mouse 10 of the present embodiment of the invention can be selectively switched among the mouse status, the speakerphone communication status and the handset communication status via detecting the orientation of the mouse 10 by the altitude sensor 14, largely increasing the practicality of the mouse 10.

In the present embodiment of the invention, as indicated in FIG. 1, the mouse 10 further includes a signal transformer 15, a signal amplifier 16 and a switch 17. The signal transformer 15 is electrically connected to the controller 11 for transforming a signal. For example, the signal transformer 15 receives and transforms a digital/analog audio signal into an analog/digital audio signal first, and outputs the analog/digital audio signal next. The signal amplifier 16 is electrically connected to the signal transformer 15 for amplifying a signal. For example, the signal amplifier 16 receives and amplifies a digital/analog audio signal first, and outputs the digital/analog audio signal next. The switch 17 electrically connected to the controller 11 and the signal amplifier 16 is selectively to be electrically connected to the first microphone 19 and the first speaker 18 or electrically connected to the second microphone 21 and the second speaker 20. When the mouse is at the speakerphone communication status, the controller 11 switches the switch 17 to electrically turn on the signal amplifier 16, the first microphone 19, and the first speaker 18, so that the mouse 10 receives and outputs the voice via the first microphone 19 and the first speaker 18. When the mouse is at the handset communication status, the controller 11 switches the switch 17 to electrically turn on the signal amplifier 16 and the second microphone 21 and the second speaker 20. The switch 17 is disposed in the signal amplifier 16, so that the mouse 10 receives and outputs voice via the second microphone 21 and the second speaker 20.

The mouse 10 further includes a first wireless communication module 13 for performing wireless signal transmission with a second wireless communication module 31 of a computer 30. Furthermore, the mouse 110 further includes a mouse input circuit 12 electrically connected to the controller 11 for sensing the shift of the mouse 10 and the instruction inputted by an operation key.

Besides, as indicated in FIGS. 2-5, the mouse 10 further includes a housing 22 having a top surface 23, a lateral surface 24 and a bottom surface 25. The lateral surface 24 is connected to the top surface 23 and the bottom surface 25. The first microphone 19 and the first speaker 18 both disposed on the top surface 23 are separated from each other. The second microphone 21 and the second speaker 20 both disposed on the bottom surface 25 are separated from each other. The controller 11, the altitude sensor 14, the signal transformer 15, the signal amplifier 16 and the switch 17 are disposed inside the housing 22. The mouse 10 is horizontally oriented when the bottom surface 25 touches to a work plane 40, that is, when the bottom surface 25 of the mouse 10 faces downwards. The mouse 10 is laterally oriented on the work plane 40 when the lateral surface 24 touches the work plane 40, that is, when the lateral surface 24 of the mouse 10 faces downwards. The mouse 10 is vertically oriented when the bottom surface 25 and the lateral surface 24 are moved away from the work plane 40, that is, when the bottom surface 25 and the lateral surface 24 of the mouse are not facing downwards, in other words, when the other lateral surface of the mouse 10 faces downwards.

As indicated in FIGS. 4-5, the mouse 10 further includes a lifting cover 26, and the bottom surface 25 further has an accommodation recess 27 corresponding to the lifting cover 26. The lifting cover 26 disposed on the bottom surface 25 can be received in the accommodation recess 27. The second microphone 21 is disposed on the lifting cover 26. For example, one side of the lifting cover 26 is pivotally connected to the hinge via the bottom surface 25, and the second microphone 21 is positioned on the inner surface of the other side of the lifting cover 26. Thus, the user may flip the lifting cover 26 open and use the mouse 10 as a handset telephone. Furthermore, the second microphone 21 can be electrically connected to the switch 17 inside the housing 22 via a flexible conductive wire, a soft cable or a soft circuit board disposed between the lifting cover 26 and the housing 22. The flexible conductive wire, the soft cable or the soft circuit board disclosed above are wouned to pass through the hinge pivotally connecting the lifting cover 26 and the housing 22 to avoid being exposed outside.

Any one who is skilled in the technology of the present embodiment of the invention will understand that the technology of the present embodiment of the invention is not limited thereto. As indicated in FIG. 2, the mouse 10 includes an operation key 28 disposed on the top surface 22 and is electrically connected to the mouse input circuit 12 of FIG. 1. The operation key 28 is used for rolling the screen reel of the computer 30 when the mouse is at the mouse status. There can be a number of press keys disposed at the front end of the top surface 23 of the mouse 10 and electrically connected to the mouse input circuit 12 of FIG. 1 for the user to operate with. The operation key 28 is used for adjusting the voice volume of the first speaker 18 when the mouse 10 is at the speakerphone communication status. The operation key 28 is used for adjusting the voice volume of the second speaker 20 when the mouse 10 is at the handset communication status.

Moreover, as indicated in FIG. 4, the mouse 10 includes a mouse shift sensing element 29, such as an optical sensor or a roller, and is exemplified by an optical sensor here. The mouse shift sensing element 29 is disposed on the bottom surface 22 and is electrically connected to the mouse input circuit 12 of FIG. 1. The mouse shift sensing element 29 is used for sensing the shift of the mouse 10 when the mouse 10 is at the mouse status. When the controller 11 receives the first sensing signal S1, the mouse shift sensing element 29 is activated to detect the shift of the mouse 10. The first wireless communication module 13 and the second wireless communication module 31 include a Bluetooth wireless communication module. The controller 11 includes a central processing unit (CPU). The altitude sensor 14 includes a gravitational altitude sensor or a gyroscope. Furthermore, the mouse 10 of the present embodiment of the invention can do without the lifting cover 26 and the accommodation recess 27, and the second microphone 21 can be disposed on the flat bottom surface 25.

Besides, the design of the mouse 10 of the present embodiment of the invention, which can do without the second speaker 20 and the second microphone 21, can use the first microphone 19 and the first speaker 18 to receive and output the voice under different reception sensitivity levels and volume magnification rates when the mouse 10 is at the speakerphone communication status and the handset communication status, respectively When the controller 11 receives the second sensing signal S2, the first microphone 19 is activated at a first reception sensitivity level, and the first speaker 18 is activated at a first volume magnification rate. When the controller 11 receives the third sensing signal S3, the first microphone 19 is activated at a second reception sensitivity level, and the first speaker 18 is activated at a second volume magnification rate. The second volume magnification rate is different from the first volume magnification rate, and the second reception sensitivity level is different from the first reception sensitivity level. Moreover, the design of the mouse 10 of the present embodiment of the invention, which can do without the first speaker 18 and the first microphone 19, can use the second microphone 21 and the second speaker 20 to receive and output the voice under reception sensitivity levels and volume magnification rates when the mouse 10 is at the speakerphone communication status and the handset communication status, respectively.

In the present embodiment of the invention, the design of applying voice over Internet protocol (VoIP) and wireless communication transmission (such as Bluetooth wireless transmission) to the mouse 10 largely transcends the restriction imposed on the design of conventional mouse, hence increasing the practicality of the mouse

### Second Embodiment

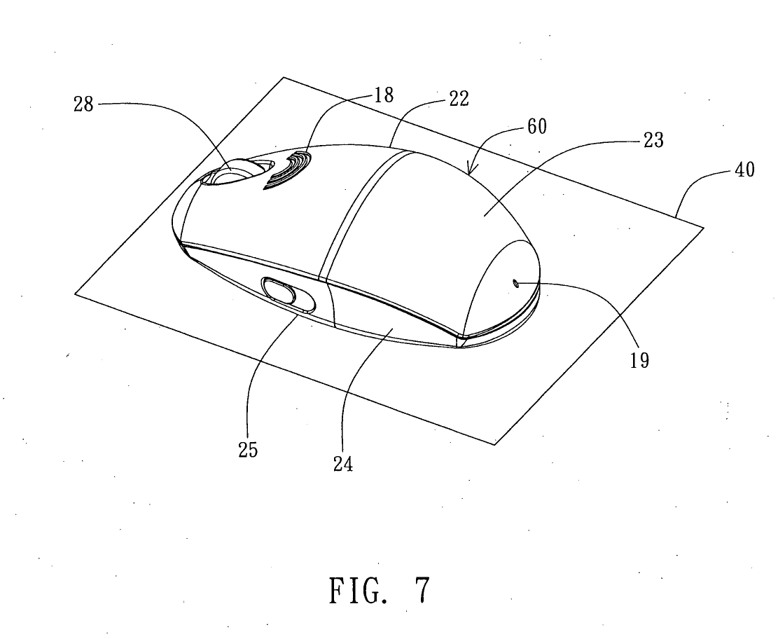

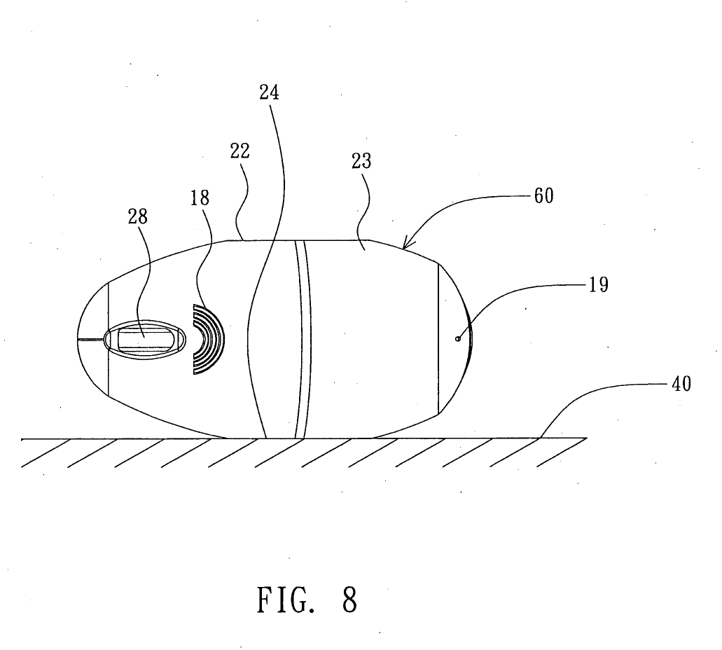

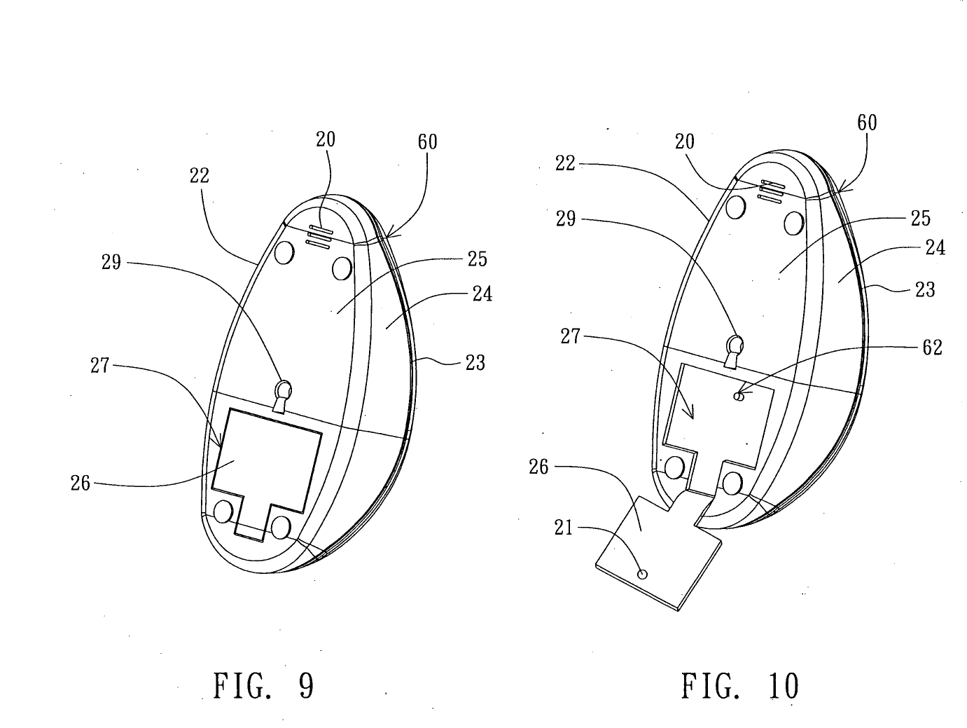

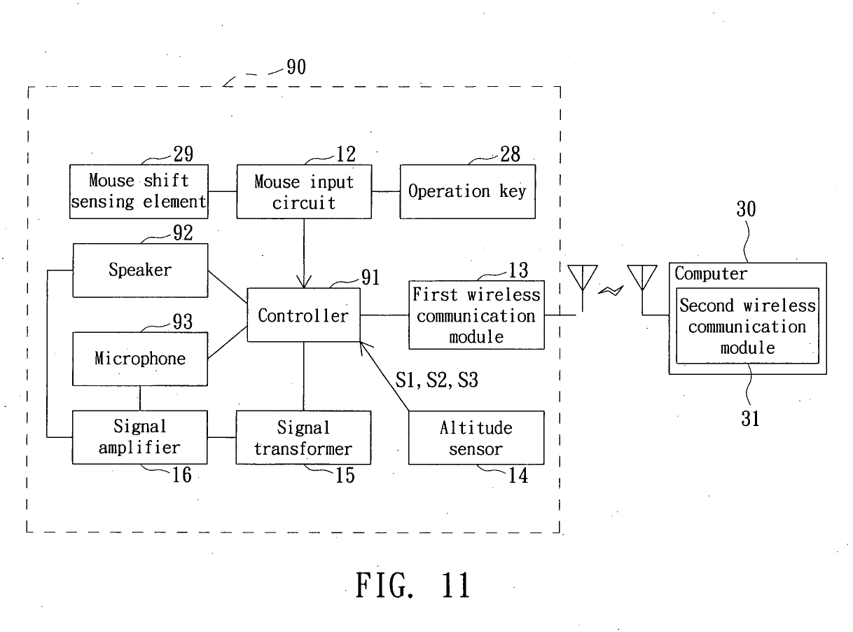

Referring to FIGS. 6-10. FIG. 6 is a circuit block diagram of a mouse and a computer according to a second embodiment FIG. 7 is a 3-D perspective of a mouse according to a second embodiment when the mouse is horizontally oriented. FIG. 8 is a 3-D perspective when the mouse of FIG. 7 is laterally oriented FIG. 9 is a 3-D perspective when the mouse of FIG. 7 is vertically oriented. FIG. 10 is a 3-D perspective when the lifting cover of the mouse of FIG. 9 is flipped open. The mouse 60 of the present embodiment of the invention differs with the mouse 10 of the first embodiment in the altitude sensor 64, the touch sensor 64 and the controller 61. As for other similar elements, the same reference numbers are used and are not repeated here.

As indicated in FIGS. 6˜10, the mouse 60 is horizontally oriented when the bottom surface 25 touches a work plane 40, and the mouse 60 is laterally oriented when the lateral surface 24 touches the work plane 40. The altitude sensor 64 is disposed inside the housing 22 for outputting a first sensing signal T1 and a second sensing signal T2 when the mouse 60 is horizontally oriented and laterally, respectively. The touch sensor 62 disposed in the accommodation recess 27 is pressed by the lifting cover 26 to output a touch signal T4 when the lifting cover 26 is disposed in the accommodation recess 27. The touch sensor 62 not pressed by the lifting cover 26 accordingly outputs a third sensing signal T3 when the lifting cover 26 is opened with respect to the bottom surface 25. The controller 61 disposed inside the housing 22 is electrically connected to the altitude sensor 64 and the touch sensor 62, respectively. The controller 61 receives the first sensing signal T1, the second sensing signal T2 and the third sensing signal T3, respectively, and accordingly switches the mouse 60 among a mouse status, a speakerphone communication status and a handset communication status. When the mouse 60 is at the speakerphone communication status, the controller 61 controls the first microphone 19 and the first speaker 18 to respectively receive and output the voice. When the mouse 60 is at the handset communication status, the controller 61 controls the second microphone 21 and the second speaker 20 to respectively receive and output the voice.

Any one who is skilled in the technology of the present embodiment of the invention will understand that the technology of the present embodiment of the invention is not limited thereto. For example, the altitude sensor 64 includes a gravitational altitude sensor or a gyroscope.

Therefore, the mouse 60 of the present embodiment of the invention uses the altitude sensor 64 to detecting the orientation of the mouse 60, and is selectively switched between the mouse status and speakerphone communication status. Besides, the mouse 60 of the present embodiment of the invention is selectively switched between the handset communication status and the speakerphone communication status according to whether the lifting cover 26 is opened. Thus, the practicality of the mouse 60 is largely increased.

### Third Embodiment

Referring to FIG. 11, a circuit block diagram of a mouse and a computer according to a third embodiment is shown. The mouse 90 of the present embodiment of the invention differs with the mouse 10 of the first embodiment in that the controller 91 controls the power for receiving and outputting voice by a set of microphone 93 and speaker 92. As for other similar elements, the same reference numbers are used and their relationships are not repeated here. Besides, the structure of the mouse 90 of the present embodiment of the invention is basically the same with that of the mouse 10 of the first embodiment, and is not repeated here.

As indicated in FIG. 11, the altitude sensor 14 is used for detecting the orientation of the mouse 90. When the first surface (such as the bottom surface of the mouse 90) of the mouse 90 faces downwards and the mouse 90 is horizontally oriented, the altitude sensor 14 outputs a first sensing signal S1. When the second surface (such as a lateral surface of the mouse 90) of the mouse 90 faces downwards and the mouse 90 is laterally oriented, the altitude sensor 14 outputs a second sensing signal S2. The controller 91 is electrically connected to the altitude sensor 14, the mouse shift sensing element 29, the speaker 92 and microphone 93, the respectively. The controller 91 is electrically connected to the mouse shift element 29 via the mouse input circuit 12. When the controller 91 receives the first sensing signal S1, the controller 91 activates the mouse shift sensing element 29 to detect the shift of the mouse 90. When the controller 91 receives the second sensing signal S2, the controller 91 activates the microphone 93 at a first reception sensitivity level, and activates the speaker 92 at a first volume magnification rate.

In the present embodiment of the invention, when the third surface (such as the other lateral surface of the mouse 90) of the mouse 90 faces downwards and the mouse 90 is vertically oriented, the altitude sensor 14 outputs a third sensing signal S3. When the controller 91 receives the third sensing signal S3, the controller 91 activates the speaker 92 at a second volume magnification rate, and activates the microphone 93 at a second reception sensitivity level. The second volume magnification rate is different from the first volume magnification rate, and the second reception sensitivity level is different from the first reception sensitivity level.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mouse, comprising:
a first microphone and a first speaker;
an altitude sensor used for outputting a first sensing signal and a second sensing signal when the mouse is horizontally and laterally orientated, respectively; and
a controller electrically connected to the altitude sensor, the first microphone and the first speaker;
wherein, the controller receives the first sensing signal and the second sensing signal, respectively, and accordingly switches the mouse among a mouse status and a speakerphone communication status;
wherein, when the mouse is at the speakerphone communication status, the controller controls the first microphone and the first speaker to respectively receive and output the voice.

2. The mouse according to claim 1, further comprising:
a second microphone and a second speaker, the altitude sensor used for further outputting a third sensing signal when the mouse is vertically orientated, the controller electrically connected to the second microphone and the second speaker;
wherein, the controller receives the third sensing signal and accordingly switches the mouse to a handset communication status;
wherein, when the mouse is at the handset communication status, the controller controls the second microphone and the second speaker to respectively receive and output the voice.

3. The mouse according to claim 2, further comprising:
a housing having a top surface, a lateral surface and a bottom surface, wherein the lateral surface is connected to the top surface and the bottom surface;
wherein, the mouse is horizontally oriented when the bottom surface touches a work plane;
wherein, the mouse is laterally oriented when the lateral surface touches the work plane;
wherein, the mouse is vertically oriented when the bottom surface and the lateral surface are moved away from the work plane;
wherein, the first microphone and the first speaker are disposed on the top surface;
wherein, the second microphone and the second speaker are disposed on the bottom surface;
wherein, the controller and the altitude sensor are disposed inside the housing.

4. The mouse according to claim 3, wherein the bottom surface has an accommodation recess, the mouse further comprises:
a lifting cover disposed on the bottom surface, wherein the lifting cover, which can be closed to and opened from the bottom surface, can be received in the accommodation recess;
wherein, the second microphone is disposed on the lifting cover.

5. The mouse according to claim 2, further comprising:
a signal transformer electrically connected to the controller for transforming a signal;
a signal amplifier electrically connected to the signal transformer for amplifying the signal; and
a switch electrically connected to the controller and the signal amplifier respectively, wherein the switch is selectively to be electrically connected to the first microphone and the first speaker or electrically connected to the second microphone and the second speaker;
wherein, when the mouse is at the speakerphone communication status, the controller switches the switch to electrically turn on the signal amplifier and the first microphone and the first speaker;
wherein, when the mouse is at the handset communication status, the controller switches the switch to electrically turn on the signal amplifier and the second microphone and the second speaker.

6. The mouse according to claim 1, further comprising:
a first wireless communication module electrically connected to the controller for performing wireless signal transmission with a second wireless communication module of a computer.

7. The mouse according to claim 1, further comprising:
a mouse input circuit electrically connected to the controller for sensing the shift of the mouse and the instruction inputted by an operation key.

8. A mouse, comprising:
a second microphone and a second speaker;
an altitude sensor used for outputting a first sensing signal and a third sensing signal when the mouse is horizontally and vertically orientated, respectively; and
a controller electrically connected to the altitude sensor, the second mocrophone and the second speaker;
wherein, the controller receives the first sensing signal and the third sensing signal, respectively, and accordingly switches the mouse among a mouse status and a handset communication status;
wherein, when the mouse is at the handset communication status, the controller controls the second microphone and the second speaker to respectively receive and output the voice.

9. The mouse according to claim 8, further comprising:
a first microphone and a first speaker;
wherein the altitude sensor used for further outputting a second sensing signal when the mouse is laterally orientated;
wherein, when the mouse is at the speakerphone communication status, the controller controls the first microphone and the first speaker to respectively receive and output the voice.

10. The mouse according to claim 9, further comprising:
a housing having a top surface, a lateral surface and a bottom surface, wherein the lateral surface is connected to the top surface and the bottom surface;
wherein, the mouse is horizontally oriented when the bottom surface touches a work plane;
wherein, the mouse is laterally oriented when the lateral surface touches the work plane;
wherein, the mouse is vertically oriented when the bottom surface and the lateral surface are moved away from the work plane;
wherein, the first microphone and the first speaker are disposed on the top surface;
wherein, the second microphone and the second speaker are disposed on the bottom surface;
wherein, the controller and the altitude sensor are disposed inside the housing.

11. The mouse according to claim 10, wherein the bottom surface has an accommodation recess, the mouse further comprises:
a lifting cover disposed on the bottom surface, wherein the lifting cover, which can be closed to and opened from the bottom surface, can be received in the accommodation recess;
wherein, the second microphone is disposed on the lifting cover.

12. The mouse according to claim 9, further comprising:
a signal transformer electrically connected to the controller for transforming a signal;
a signal amplifier electrically connected to the signal transformer for amplifying the signal; and
a switch electrically connected to the controller and the signal amplifier respectively, wherein the switch is selectively to be electrically connected to the first microphone and the first speaker or electrically connected to the second microphone and the second speaker;
wherein, when the mouse is at the speakerphone communication status, the controller switches the switch to electrically turn on the signal amplifier and the first microphone and the first speaker;
wherein, when the mouse is at the handset communication status, the controller switches the switch to electrically turn on the signal amplifier and the second microphone and the second speaker.

13. The mouse according to claim 8, further comprising:
a first wireless communication module electrically connected to the controller for performing wireless signal transmission with a second wireless communication module of a computer.

14. The mouse according to claim 8, further comprising:
a mouse input circuit electrically connected to the controller for sensing the shift of the mouse and the instruction inputted by an operation key.

15. A mouse, comprising:
an altitude sensor used for detecting the orientation of the mouse, wherein when the first surface of the mouse faces downwards, the altitude sensor outputs a first sensing signal; and when the second surface of the mouse faces downwards, the altitude sensor outputs a second sensing signal; and
a controller electrically connected to the altitude sensor;
wherein, when the controller receives the first sensing signal, the mouse is set at a first status;
wherein, when the controller receives the second sensing signal, the mouse is set at a second status.

16. The mouse according to claim 15, wherein the first status is a mouse status and the second status is a speakerphone communication status.

17. The mouse according to claim 15, wherein when the third surface of the mouse faces downwards, the altitude sensor outputs a third sensing signal;
wherein, when the controller receives the third sensing signal, the mouse is set at a third status.

18. The mouse according to claim 15, wherein the third status is a handset communication status.
